(19) United States
(12) Patent Application Publication
(10) Pub. No.: US 2009/0150399 A1
(43) Pub. Date: Jun. 11, 2009

(54) Method of Improving Remote Desktop Performance

(76) Inventor: Paritosh D. Patel, Parkland, FL (US)

Correspondence Address: DILLON & YUDELL LLP, 8911 N. CAPITAL OF TEXAS HWY., SUITE 2110, AUSTIN, TX, 78759, US

(21) Appl. No.: 11/951,551

(22) Filed: Dec. 6, 2007

(51) Int. Cl. G06F 17/30

(52) U.S. Cl. 707/10; 707/E17.032

(57) ABSTRACT

A method of improving remote desktop performance tags each resource file in local storage on a remote computer with a globally unique identifier (GUID). When the local computer renders a first resource file tagged with a first GUID, the local computer sends the first GUID to a local computer. The local computer determines if it has the first resource file stored in local storage. If the local computer has the first resource file stored in said local storage, the local computer renders the stored first resource. If the local computer does not have the first resource file stored in local storage, the local computer requests the first resource from the remote computer.

### BACKGROUND OF THE INVENTION

1. Technical Field

The present invention relates generally to the field of remote desktop computing, and more particularly to a method of improving remote desktop performance and reducing network bandwidth requirements by transporting to a local computer globally unique identifiers (GUIDs) assigned to resource files rendered on a remote computer, rather than the resource files themselves.

2. Description of the Related Art

Remote desktop applications have become very useful. A remote desktop application enables a remote computer to be operated from a local computer. The remote desktop application transports the user interface desktop over a network from the remote computer to the local computer. The remote computer is typically an individual's primary computer. Using a remote desktop application, the individual can log onto the remote computer from a local computer and work from the local computer. Remote desktop applications are also useful to system administrators and help desk technicians, who can take control of a remote computer from a local computer to diagnose or fix problems.

As personal computing in general and remote desktop computing in particular have improved, large resource files, such as audio files, image files and bitmaps, and video or animation files, are commonly rendered on the desktop of the remote computer's desktop. Some resource files, such as standard audio files, come with the operating system and are thus common to all computers with the same operating system. However, most resource files are added as new applications are installed. Currently, such resource files must be transported to the local computer for rendering. The transport of resource files slows the performance to the desktop on the local computer and takes up network bandwidth.

### SUMMARY OF THE INVENTION

The present invention provides a method of improving remote desktop performance. The method tags each resource file in local storage on a remote computer with a globally unique identifier (GUID). The method may also tag each special rendering software application on the remote computer with a GUID. When the local computer renders a first resource file tagged with a first GUID, the local computer sends the first GUID to a local computer. The local computer determines if it has the first resource file stored in local storage. If the local computer has the first resource file stored in said local storage, the local computer renders the stored first resource. If the local computer does not have the first resource file stored in local storage, the local computer requests the first resource from the remote computer.

In some embodiments of the present invention, the remote computer may maintain a record of GUID-tagged resource files stored in local storage of the local computer. The remote computer sends the GUID for a GUID-tagged resource to the local computer if the record shows the local computer to have the GUID-tagged resource file in local storage. The remote computer sends sends GUID-tagged resource file to the local computer if the record shows the local computer not to have the GUID-tagged resource file in local storage.

The remote computer may perform a special rendering of a GUID-tagged resource file. An example of special rendering is rendering a color image in black-and-white. Special rendering may require special software on the rendering computer. The remote computer sends instructions to the local computer to perform the special rendering on the GUID-tagged resource file. The local computer performs the special rendering if the local computer has the special software. The local computer requests a specially rendered version of the GUID-tagged resource file if the local computer does not have the special software. Alternatively, the local computer may request the special software from the remote computer.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of an embodiment of a system according to the present invention;

FIG. 2 is a flow chart of an embodiment of remote computer resource database initialization according to the present invention;

FIG. 3 is a flow chart of an embodiment of remote computer resource processing according to the present invention; and,

FIG. 4 is flow chart of an embodiment of local computer resource processing according to the present invention.

### DETAILED DESCRIPTION OF THE PREFERRED EMBODIMENT

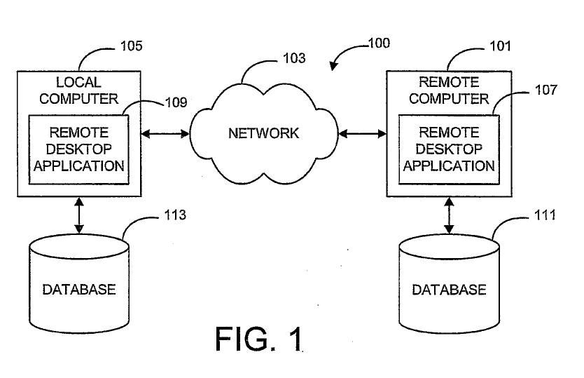

Referring now to the drawings, and first to FIG. 1, a system according to the present invention is designated generally by the numeral 100. System 100 includes a remote computer 101. Remote computer 101 may be any type of computer such as a personal computer, notebook computer, or the like. Remote computer 101 may have installed thereon any suitable operating system. Remote computer 101 is typically the primary computer associated with an individual. Remote computer 101 is coupled to a network 103. Network 103 may include a local area network, a wide area network, the Internet, a telephone network, or combination of such networks.

System 100 includes a local computer 105 coupled to network 103. As in the case of remote computer 101, local computer 105 may be any type of computer, such as a personal computer, a notebook computer, or the like. Local computer 105 may have installed thereon in a suitable operating system, which may be the same as or different from the operating system of remote computer 101. Local computer 105 is the computer that a user of system 101 operates. User of local computer 105 may be the owner or registered user of remote computer 101. The user of local computer 105 may also be a system administrator or a help desk technician.

Remote computer 101 has installed thereon a remote desktop application 107. Similarly, local computer 105 has installed thereon a remote desktop application 109. Typically, remote desktop application 107 is a server application while remote desktop application 109 is a client application. As is known to those skilled in the art, remote desktop applications, such as applications 107 and 109, enable local computer 105 to emulate the desktop of remote computer 101. Thus, the user of local computer 105 is able to view and interact with the desktop of remote computer 101 as if the user were present and operating remote computer 101. Examples of remote desktop applications include Windows® Remote Desktop Application and RealVNC™, as well as other well-known applications.

Remote computer 101 has associated therewith a database 111. Database 111 can be a database application such as IBM DB2, MySQL, etc., or a simple text file held in memory or a direct access storage device associated with remote computer 101, or a network storage, or any other data repository. Database 111 contains the resource files used by remote computer 101. Resource files are typically large files such as audio files, bitmaps, video clips, and the like, that are rendered on the desktop a remote computer 101. Database 111 may also contain special software applications used by the remote computer to perform special rendering of resource files. An example of special rendering is rendering a color image in black and white or grayscale.

According to the present invention, each resource file and special rendering software application in database 111 is tagged with a Globally Unique Identifier (GUID). As is known to those skilled in the art, a GUID is a special type of identifier that is used to provide a reference number that is unique in the context for which it is used. Several well-known algorithms are commonly available for generating GUIDs. While each generated GUID is not guaranteed to be unique, the total number of unique GUIDs (2¹²² or 5.3×10³⁶) is so large that the probability of the same number being generated twice in any particular context is very small. Thus, according to the present invention, each resource file and special rendering application in database 111 is uniquely identified by a GUID.

Local computer 105 has associated therewith a database 113. As in the case of database 111, database 113 can be a database application such as IBM DB2, MySQL, etc., or a simple text file held in memory or a direct access storage device associated with remote computer 105, or network storage, or any other data repository. As will be explained in detail hereinafter, database 113 contains some or all of the resource files and special rendering applications used by remote computer 101. Each resource file and special rendering application stored in database 113 is tagged with the same GUID as the corresponding resource file stored in database 111.

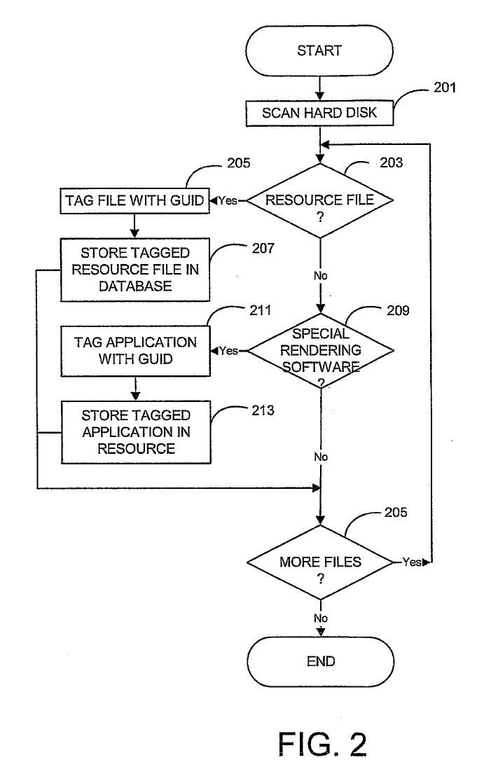

FIG. 2 is a flow chart of an embodiment of the process of initializing or creating database 111. As indicated at block 201, remote desktop application 107 scans the hard disk of remote computer 101. The remote desktop application determines, at decision block 203, if a particular file is a resource file. If so, the remote desktop application tags the resource file with a GUID, as indicated at block 205, and stores the tagged resource file in the database, as indicated at block 207. The remote desktop application may generate a GUID using a commonly available algorithm, or it may take a GUID from a table or list of previously generated GUIDs. If, as determined at decision block 203, the file is not a resource file, the remote computer determines at decision block 209 if the file is a special rendering software application. If so, the remote computer tags the application with a GUID, as indicated at block 211, and stores the tagged application in the database, as indicated at block 213. Processing according to FIG. 2 continues until, as determined at decision block 215, all files on the hard disk of the remote computer 101 have been scanned.

In an alternative embodiment, the remote desktop application can come with preassembled databases for various operating systems, wherein each preassembled database comes with the resources for a specific operating system and their corresponding GUIDs. When a connection is made between the local computer and the remote computer, the local computer tells the remote computer which operating system it uses. Having a preassembled database will improve performance on the first connection between the local and remote computers. Also, during installation of the remote desktop application, the user can choose which operating system database or database to install.

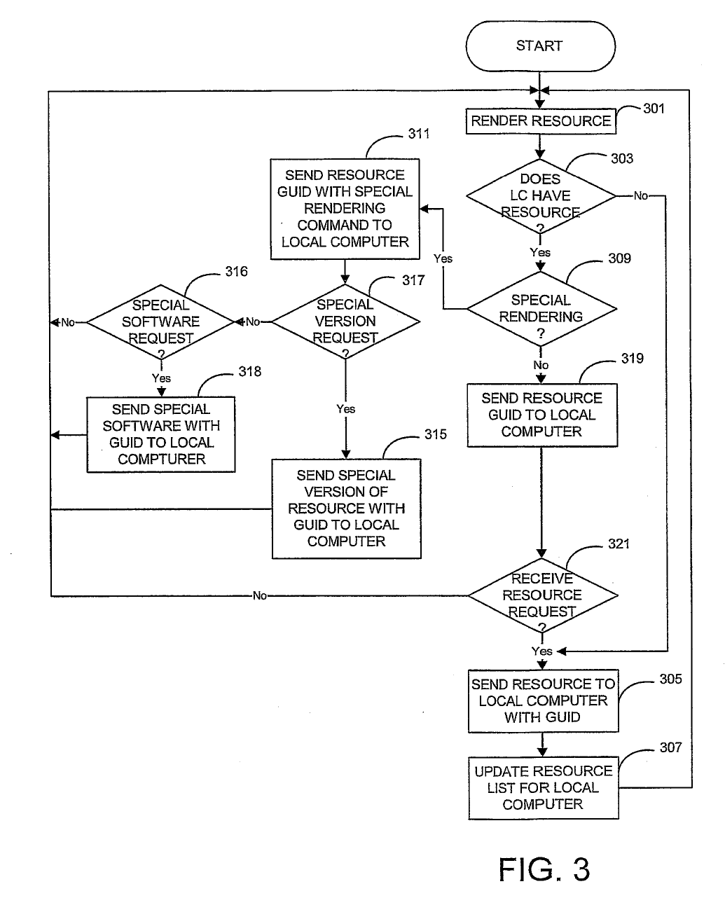

FIG. 3 is a flow chart of remote computer resource processing according to an embodiment of the present invention. The remote computer renders a resource, as indicated at block 301. In some embodiments of the present invention, the remote computer maintains a record of the resource files that the local computer has stored in its local database. The remote computer determines, at decision block 303 if the local computer has the resource. If not, the remote computer sends the resource file tagged with a GUID to the local computer, as indicated at block 305, and updates the resource list for the local computer, at block 307.

If, as determined at decision block 303, the local computer does have the resource file rendered at block 301, the remote computer determines, at decision block 309, if special rendering was used to render the resource file. An example of special rendering is rendering a color image in black and white. If special rendering was used, the remote computer sends the GUID of the resource to the local computer with a special rendering command, at block 311. The remote computer waits to see if a special version request is received. The local computer can execute the special rendering command only if it has a special software application needed for the special rendering. If the local computer cannot execute the special rendering command, it must request a rendered special version or the special rendering application. If, as determined at decision block 313, the remote computer receives a special version request, the remote computer sends a special version of a resource file with its GUID to the local computer, as indicated at block 315. If as determined at decision block 316, the remote computer receives a special software request, the remote computer sends the special rendering software application with its GUID to the local computer, as indicated at block 318.

If, as determined at decision block 309, special rendering is not required, the remote computer sends the GUID of the resource file to the local computer at block 319. Occasionally, in the embodiment in which the remote computer maintains a record of GUI-tagged resource files stored at the local computer, there may be a mismatch. For example, the local computer may have deleted certain GUID-tagged resource files from its database. Accordingly, the remote computer may wait to see it receives a resource request from the local computer. Also, maintenance by the local computer of a record of GUID-tagged files stored with the local computer is optional. In some embodiments, the remote computer skips decision block 303 and sends a resource GUID to the local computer every time the remote computer renders a resource file. If, as determined at decision block 321, the remote computer receives a resource request, the remote computer sends the GUID-tagged resource file to the local computer, at block 305.

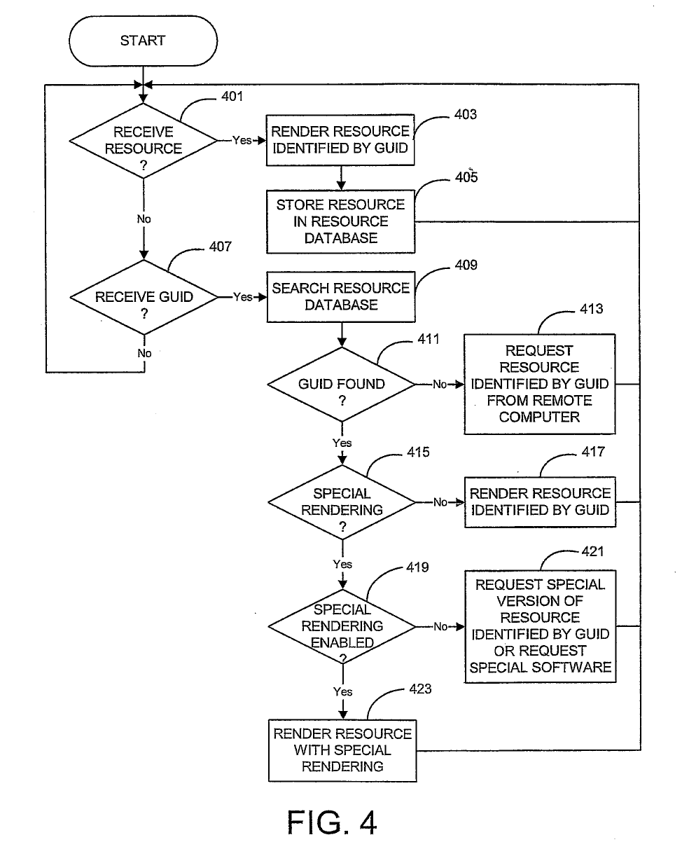

FIG. 4 is a flow chart of an embodiment of local computer resource file processing according to the present invention. If, as determined at decision block 401, the local computer receives a resource file, the local computer renders the resource file, at block 403, and stores the resource file in its database, at block 405. If, as determined at decision block 407, the local computer receives a GUID, it searches its database for the GUID, as indicated at block 409. If, as determined at decision block 411, the GUID is not found, the local computer requests the resource file identified by the GUID, at block 413. If, as determined at decision block 411, the GUID is found, the local computer checks, at decision block 415, if special rendering is required. If not, the local computer renders the resource identified by the GUID, at block 417. If, as determined at decision block 415, special rendering is required, the local computer checks, at decision block 419, if special rendering is enabled. Special rendering is enabled if the local computer has the special software application required for the specified special rendering. If, as determined at decision block 419, special rendering is not enabled, the local computer may request a special version of the resource file identified by the GUID or the special software, at block 421. If special rendering is enabled, the local computer renders the resource file with special rendering, at block 423.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. Accordingly, the foregoing description is intended for purposes of illustration and not of limitation.

What is claimed is:

1. A method of improving remote desktop performance, which comprises:
rendering on a remote computer a resource file tagged with a globally unique identifier (GUID);
sending said GUID to a local computer;
determining if said local computer has the resource file tagged with said GUID stored in local storage;
rendering said stored resource on said local computer if it is determined said local computer has said resource file stored in said local storage; and,
requesting said resource from said remote computer if it is determined said local computer does not have said resource file stored in said local storage.

2. The method as claimed in claim 1, further comprising:
tagging each resource file in local storage on said remote computer with a GUID.

3. The method as claimed in claim 1, further comprising:
maintaining on said remote computer a record of GUID-tagged resource files stored in local storage on said local computer;
sending a GUID to said local computer if said local computer has said GUID-tagged resource file in said local storage; and,
sending said GUID-tagged resource file to said local if said local computer does not have said GUID-tagged resource file stored in said local storage.

4. The method as claimed in claim 1, further comprising:
performing a special rendering of said GUID-tagged resource file on said remote computer; and,
sending instructions to said local computer to perform said special rendering on a file in local storage on said local computer tagged with said GUID.

5. The method as claimed in claim 4, wherein said special rendering requires special software, and said method further comprises:
performing said special rendering on said local computer if said local computer has said special software; and,
requesting a specially rendered version of said GUID-tagged resource file if said local computer does not have said special software.

6. The method as claimed in claim 5, further comprising:
sending said specially rendered version to said local computer.

7. The method as claimed in claim 4, wherein said special rendering requires special software, and said method further comprises:
performing said special rendering on said local computer if said local computer has said special software; and,
requesting said special software if said local computer does not have said special software.

8. The method as claimed in claim 7, further comprising:
sending said special software to said local computer.

9. The method as claimed in claim 1, further comprising:
sending the GUID-tagged resource file to said local computer;
rendering said GUID-tagged resource file received from said remote computer on said local computer; and,
storing said GUID-tagged resource file received from said remote computer in local storage on said local computer.

10. A method of improving remote desktop performance, which comprises:
tagging each resource file in local storage on a remote computer with a globally unique identifier (GUID);
rendering on said remote computer a first resource file tagged with a first GUID;
sending said first GUID to a local computer;
determining if said local computer has said first resource file stored in local storage;
rendering said stored first resource on said local computer if it is determined said local computer has said first resource file stored in said local storage; and,
requesting said first resource from said remote computer if it is determined said local computer does not have said resource file stored in said local storage.

11. The method as claimed in claim 10, further comprising:
maintaining on said remote computer a record of GUID-tagged resource files in local storage on said local computer;
sending the GUID for a GUID-tagged resource to said local computer if said local computer has said GUID-tagged resource file in said local storage; and,
sending said GUID-tagged resource file to said local computer if said local computer does not have said GUID-tagged resource file in said local storage.

12. The method as claimed in claim 10, further comprising:
performing a special rendering of a GUID-tagged resource file on said remote computer; and,
sending instructions to said local computer to perform said special rendering on a file in local storage on said local computer tagged with said GUID.

13. The method as claimed in claim 12, wherein said special rendering requires special software, and said method further comprises:
performing said special rendering on said local computer if said local computer has said special software; and,
requesting a specially rendered version of said GUID-tagged resource file if said local computer does not have said special software.

14. The method as claimed in claim 13, further comprising:
sending said specially rendered version to said local computer.

15. The method as claimed in claim 12, wherein said special rendering requires special software, and said method further comprises:
performing said special rendering on said local computer if said local computer has said special software; and,
requesting said special software if said local computer does not have said special software.

16. The method as claimed in claim 15, further comprising:
sending said special software to said local computer.

17. The method as claimed in claim 10, further comprising:
sending said first resource file to said local computer; and,
rendering said first resource file received from said remote computer on said local computer.
